(19) United States
(12) Patent Application Publication
(10) Pub. No.: US 2006/0176583 A1
(43) Pub. Date: Aug. 10, 2006

(54) Lens holder assembly of optical pickup and method of producing same

(75) Inventors: Young Su Jin, Gyeonggi-do (KR); In Cheol Chang, Gyeonggi-do (KR); Ho Seop Jeong, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/345,257

(22) Filed: Jan. 31, 2006

(30) Foreign Application Priority Data
Feb. 4, 2005 (KR) 10-2005-0010474

(51) Int. Cl. G02B 7/02

(52) U.S. Cl. 359/811

(57) ABSTRACT

Disclosed is a lens holder assembly which includes a silicon substrate, a lens supporter, a glass plate, a diffraction member, and an aspheric lens. A coupling opening is formed through the center of the silicon substrate by wet etching so as to have an inclined wall. The lens supporter is provided in the coupling opening of the silicon substrate. A mount opening, on which an objective is to be mounted, and a through opening, through which light beams pass, are formed through the center of the lens supporter. The glass plate is attached to a lower side of the silicon substrate so as to be penetrated with the light beams and to close the coupling opening, the diffraction member is attached to a lower side of the glass plate, and the aspheric lens is formed on a portion of an upper side of the glass plate which is exposed by the through opening formed through the lens supporter.

### INCORPORATION BY REFERENCE

The present application claims priority under 35 U.S.C. §119 to Korean Patent Application No. 10-2005-0010474 filed on Feb. 4, 2005. The content of the application is incorporated herein by reference in its entirety.

### BACKGROUND OF THE INVENTION

1. Field of the Invention

The present invention relates, in general, to an optical pickup and, more particularly, to a lens holder assembly of an optical pickup, which can be easily produced and mass-produced using a wet etching process, and a method of producing same.

2. Description of the Prior Art

An optical pickup is a device in which light beams are radiated onto optical disks, such as CDs, DVDs, or BDs, used as optical information recording media, and the light beams reflected from the optical disks are received to record information on recording surfaces of the optical disks or to read recorded information.

The optical pickup is provided with an objective as a unit for condensing the light beams, which are emitted from a light source, onto the optical disks, and the objective mounted on a lens holder is moved in the optical axis, or tracking or tilting direction by an actuator.

The objective is mounted on an upper side of the lens holder and a glass plate is attached to a lower side of the lens holder, thereby forming an assembly. A diffraction plate may be integrated with a lower side of the glass plate to correct chromatic aberrations.

Such a lens holder assembly 70 includes a lens supporter 71, a glass plate 72, and a diffraction plate 73 as shown in FIG. 8.

The lens supporter 71 is made of synthetic resin. A mount opening 71a, in which an objective 74 is to be mounted, and a through opening 71b, through which light beams pass, are integrally formed through the center of the lens supporter.

The glass plate 72 is attached to a lower side of the lens supporter 71 to support the lens supporter 71, and is transparent to be penetrated with the light beams.

The diffraction plate 73 is attached to a lower side of the glass plate 72 so as to be perpendicular to an optical axis, and serves to correct chromatic aberrations of the light beams.

As shown in FIG. 9, the conventional lens holder assembly 70 having the above structure is produced through the following procedure.

First, a predetermined amount of synthetic resin 2 is fed into a female frame 1 of a mold.

Subsequently, a male frame 3 is assembled with the female frame 1, and synthetic resin 2 is heated and pressurized to shape the lens supporter 71 and then cooled.

Next, the lens supporter 71 is separated from the mold. The lens supporter 71 has a mount opening 71a, in which the objective is to be mounted, and a through opening 71b, through which the light beams pass, integrally formed therethrough.

The glass plate 72 is then attached to the lower side of the lens supporter 71.

Subsequently, the diffraction plate 73 is attached to the lower side of the glass plate 72, and the objective 74 is mounted on the lens supporter 71 so as to be closely fitted into the mount opening 71a, after which bonding is conducted.

It is possible to mass-produce the lens supporter 71 of the conventional lens holder assembly 70 having the above structure using a mold.

Even though the lens supporter 71 can be mass-produced, a process of attaching the glass plate 72 to the lens supporter 71, a process of attaching the diffraction plate 73 to the glass plate 72, and a process of mounting the objective 74 on the lens supporter 71 are repeated for every lens supporter 71, thus the production time is long.

Additionally, since the glass plate 73 is attached to the lens supporter 71 made of synthetic resin using attaching means, such as a bonding agent, it is difficult to alignment between the lens supporter 71 and the diffraction plate 73.

### SUMMARY OF THE INVENTION

Accordingly, the present invention has been made keeping in mind the above problems occurring in the prior art, and an object of the present invention is to provide a lens holder assembly and a method of producing same, in which a wafer-sized silicon mother substrate or glass mother substrate is wet etched to simultaneously form a plurality of coupling openings or coupling recesses, and a glass plate or a diffraction member is directly attached to the silicon mother substrate or glass mother substrate, thereby making easy production and mass-production possible.

Another object of the present invention is to provide a lens holder assembly and a method of producing same, in which thermosetting polymer(thermosetting polymer or UV curable polymer) is molded on a silicon substrate or a glass substrate to integrally form a lens supporter and an aspheric lens, thus providing two lenses, resulting in desirable correction of various aberrations

Still object of the present invention is to provide a lens holder assembly, in which a lens supporter is produced using a silicon substrate or a glass substrate so as to desirably withstand external impact or heat, and a method of producing same.

The above objects can be accomplished by providing a lens holder assembly of an optical pickup. The lens holder assembly includes a silicon substrate member through which a coupling opening having a predetermined size is formed by wet etching, a lens supporter which is provided in the coupling opening of the silicon substrate member and on which an objective is to be mounted, and a transparent member which is attached to a lower side of the silicon substrate member, so as to close the coupling opening, and which is penetrated with light beams.

The lens holder assembly may also include a diffraction member for correcting chromatic aberrations of the light beams on a lower side of the transparent member.

Furthermore, the transparent member may include an aspheric lens on a portion of an upper side thereof which is exposed by the coupling opening.

Additionally, the lens supporter and the aspheric lens may be made of thermosetting polymer or ultraviolet (UV) curable polymer.

As well, the aspheric lens may be integrally formed in conjunction with the lens supporter using a predetermined mold.

Furthermore, the transparent member may include a diffraction member for correcting chromatic aberrations of the light beams on a portion of an upper side thereof, which is exposed by the coupling opening.

Furthermore, the lens supporter and the diffraction member may be made of thermosetting polymer or UV curable polymer.

Additionally, the diffraction member may be integrally formed in conjunction with the lens supporter using a predetermined mold.

Furthermore, the present invention provides a lens holder assembly of an optical pickup characterized in that the lens holder assembly includes a glass substrate member, on which a coupling recess having a predetermined size is formed by wet etching, and a lens supporter, which is provided in the coupling recess of the glass substrate member and on which an objective is to be mounted.

The lens holder assembly may also include a diffraction member for correcting chromatic aberrations of light beams on a lower side of the glass substrate member.

Furthermore, the glass substrate member may include an aspheric lens on the bottom of the coupling recess.

In addition, the lens supporter and the aspheric lens may be made of thermosetting polymer or UV curable polymer.

As well, the aspheric lens is integrally formed in conjunction with the lens supporter using a predetermined mold.

Additionally, the glass substrate member may include the diffraction member for correcting chromatic aberrations of light beams on the bottom of the coupling recess.

Additionally, the lens supporter and the diffraction member may be made of thermosetting polymer or UV curable polymer.

Furthermore, the diffraction member may be integrally formed in conjunction with the lens supporter using a predetermined mold.

Furthermore, the present invention provides a method of producing a lens holder assembly of an optical pickup. The method includes the steps of forming a plurality of coupling recesses on a wafer-sized silicon substrate member by wet etching, cutting a portion of the silicon substrate member so as to convert the coupling recesses into coupling openings, attaching a transparent member to a lower side of the silicon substrate member having a spherical shape so as to close the coupling openings, feeding polymers into the coupling openings, shaping the polymers into lens supporters using a predetermined mold, and cutting the silicon substrate member into lens holder assemblies.

The method may also include the steps of attaching a diffraction member, for correcting chromatic aberrations of light beams, to a lower side of the transparent member after the shaping step.

Additionally, aspheric lenses may be integrally formed in conjunction with the lens supporters on portions of an upper side of the transparent member, which is exposed by coupling openings in the shaping step.

As well, diffraction members may be integrally formed in conjunction with the lens supporters on the portions of the upper side of the transparent member, which is exposed by the coupling openings in the shaping step.

Furthermore, the present invention provides a method of producing a lens holder assembly of an optical pickup, which includes the steps of forming a plurality of coupling recesses on a wafer-sized glass substrate member by wet etching, feeding polymers into the coupling recesses, shaping the polymers into lens supporters using a predetermined mold, and cutting the glass substrate member into lens holder assemblies.

The method may also include the step of attaching a diffraction member, for correcting chromatic aberrations of light beams, to a lower side of the glass substrate member after the shaping step.

Furthermore, aspheric lenses may be integrally formed in conjunction with the lens supporters on bottoms of the coupling recesses in the shaping step.

Additionally, diffraction members may be integrally formed in conjunction with the lens supporters on the bottoms of the coupling recesses in the shaping step.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic sectional view of a lens holder assembly of an optical pickup, according to an embodiment of the present invention;

FIG. 2 is a schematic sectional view of a lens holder assembly of an optical pickup, according to another embodiment of the present invention;

FIG. 3 is a schematic sectional view of a lens holder assembly of an optical pickup, according to yet another embodiment of the present invention;

FIG. 4 is a schematic sectional view of a lens holder assembly of an optical pickup, according to a further embodiment of the present invention;

FIG. 5 schematically illustrates the production of the lens holder assembly of FIG. 1;

FIG. 6 schematically illustrates the production of the lens holder assembly of FIG. 3;

FIG. 7 schematically illustrates a silicon mother substrate or a glass mother substrate on which a plurality of coupling openings or coupling recesses is formed;

FIG. 8 is a schematic sectional view of a lens holder assembly of an optical pickup, according to conventional technology; and

FIG. 9 schematically illustrates the production of the lens holder assembly of FIG. 8.

### DETAILED DESCRIPTION OF THE INVENTION

Hereinafter, a detailed description will be given of a lens holder assembly and a method of producing same according to the present invention, with reference to the accompanying drawings.

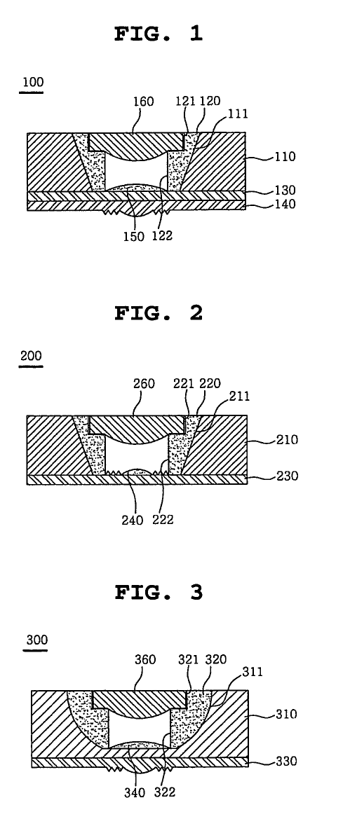

As shown in FIG. 1, a lens holder assembly 100 according to an embodiment of the present invention includes a silicon substrate 110, a lens supporter 120, a glass plate 130, a diffraction member 140, and an aspheric lens 150.

A coupling opening 111 is formed through the center of the silicon substrate 110 by wet etching a silicon substrate member, and has an inclined wall because the silicon substrate 110 is isotropic.

The lens supporter 120 is made of thermosetting polymer or UV curable polymer, and is provided in the coupling opening 111 of the silicon substrate 110. Furthermore, a mount opening 121, on which an objective 160 for condensing light beams emitted from a light source on an optical disk is to be mounted, and a through opening 122, through which the light beams pass, are integrally formed through the center of the lens supporter 120.

The glass plate 130 is a transparent member that is penetrated with the light beams and closes the coupling opening 111, and it is attached to a lower side of the silicon substrate 110 using attaching means, such as an anodic bonding.

The diffraction member 140 is a unit for correcting chromatic aberrations of the light beams, and is attached to a lower side of the glass plate 130. The diffraction member 140 is produced using polymer through a UV embossing process or a HOT embossing process. However, if the diffraction member 140 is not strongly attached to the glass plate 130, a thin adhesive layer may further be provided between the diffraction member 140 and the glass plate 130 so that the glass plate 130 is strongly attached to the diffraction member 140.

The aspheric lens 150 is a unit for correcting various aberrations, and provided on a portion of an upper side of the glass plate 130, which is exposed by the through opening 122 formed through the lens supporter 120. Like the lens supporter 120, the aspheric lens 150 is made of thermosetting polymer or UV curable polymer, and it is preferable to integrally simultaneously form the lens supporter 120 and the aspheric lens using a mold.

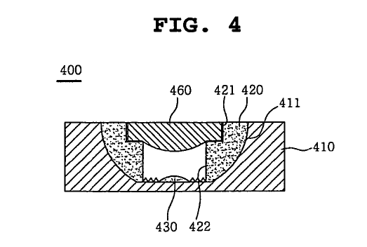

As shown in FIG. 2, a lens holder assembly 200 according to another embodiment of the present invention includes a silicon substrate 210, a lens supporter 220, a glass plate 230, and a diffraction member 240.

A coupling opening 211 is formed through the center of the silicon substrate 210 by wet etching a silicon substrate member, and has an inclined wall because the silicon substrate 210 is isotropic.

The lens supporter 220 is made of thermosetting polymer or UV curable polymer, and is provided in the coupling opening 211 of the silicon substrate 210. Furthermore, a mount opening 221, on which an objective 260 for condensing light beams emitted from a light source on an optical disk is to be mounted, and a through opening 222, through which the light beams pass, are integrally formed through the center of the lens supporter 220.

The glass plate 230 is a transparent member that is penetrated with the light beams and closes the coupling opening 211, and it is attached to a lower side of the silicon substrate 210 using attaching means, such as an anodic bonding.

The diffraction member 240 is a unit for correcting chromatic aberrations of the light beams, and is provided on a portion of an upper side of the glass plate 230, which is exposed by the through opening 222 formed through the lens supporter 220. Like the lens supporter 220, the diffraction member 240 is made of thermosetting polymer or UV curable polymer, and it is preferable to integrally and simultaneously form the lens supporter 220 and the diffraction member using a mold.

As shown in FIG. 3, a lens holder assembly 300 according to yet another embodiment of the present invention includes a glass substrate 310, a lens supporter 320, a diffraction member 330, and an aspheric lens 340.

A coupling recess 311 is formed on the center of the glass substrate 310 by wet etching, and has a flat bottom and a curved wall because the glass substrate 310 is anisotropic.

The lens supporter 320 is made of thermosetting polymer or UV curable polymer, and is provided in the coupling recess 311 of the glass substrate 310. Furthermore, a mount opening 321, on which an objective 360 for condensing light beams emitted from a light source on an optical disk is to be mounted, and a through opening 322, through which the light beams pass, are integrally formed through the center of the lens supporter 320.

The diffraction member 330 is a unit for correcting chromatic aberrations of the light beams, and is attached to a lower side of the glass substrate 310. The diffraction member 330 is produced using thermosetting polymer through a UV embossing process or a HOT embossing process. However, if the diffraction member 330 is not strongly attached to the glass substrate 310, a thin adhesive layer may further be provided between the diffraction member 330 and the glass substrate 310 so that the diffraction member 330 is strongly attached to the glass substrate 310.

The aspheric lens 340 is a unit for correcting various aberrations, and is provided on a portion of an upper side of the glass substrate 310, which is exposed by the through opening 322 formed through the lens supporter 320. Like the lens supporter 320, the aspheric lens 340 is made of thermosetting polymer or UV curable polymer, and it is preferable to integrally simultaneously form the lens supporter 320 and the aspheric lens using a mold.

As shown in FIG. 4, a lens holder assembly 400 according to a further embodiment of the present invention includes a glass substrate 410, a lens supporter 420, and a diffraction member 430.

A coupling recess 411 is formed on the center of the glass substrate 410 by wet etching a glass substrate member, and has a flat bottom and a curved wall because the glass substrate 410 is anisotropic.

The lens supporter 420 is made of thermosetting polymer or UV curable polymer, and is provided in the coupling recess 411 of the glass substrate 410. Furthermore, a mount opening 421, on which an objective 460 for condensing light beams emitted from a light source on an optical disk is to be mounted, and a through opening 422, through which the light beams pass, are integrally formed through the center of the lens supporter 420.

The diffraction member 430 is a unit for correcting chromatic aberrations of the light beams, and is provided on a portion of an upper side of the glass substrate 410, which is exposed by the through opening 422 formed through the lens supporter 420. Like the lens supporter 420, the diffraction member 430 is made of thermosetting polymer or UV curable polymer, and it is preferable to integrally simultaneously form the lens supporter 420 and the diffraction member using a mold.

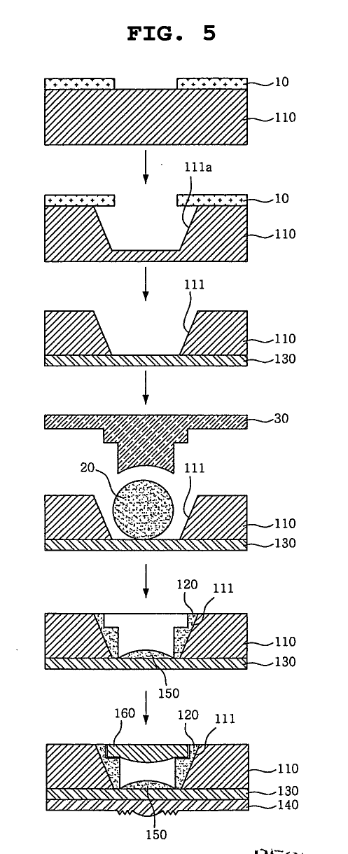

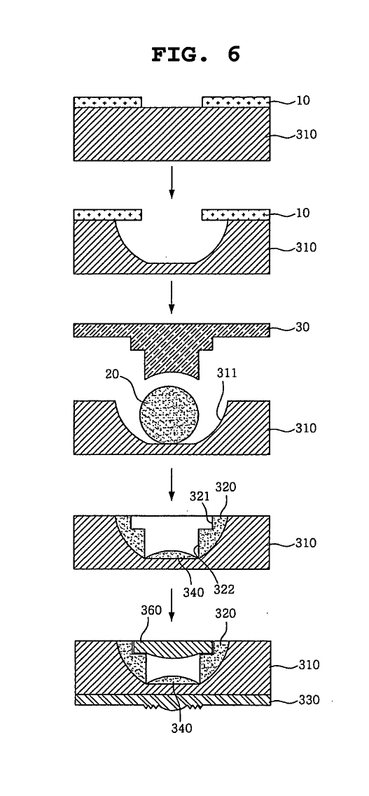

Hereinafter, a description will be given of the production of the lens holder assembly 100 of FIG. 1, with reference to FIG. 5.

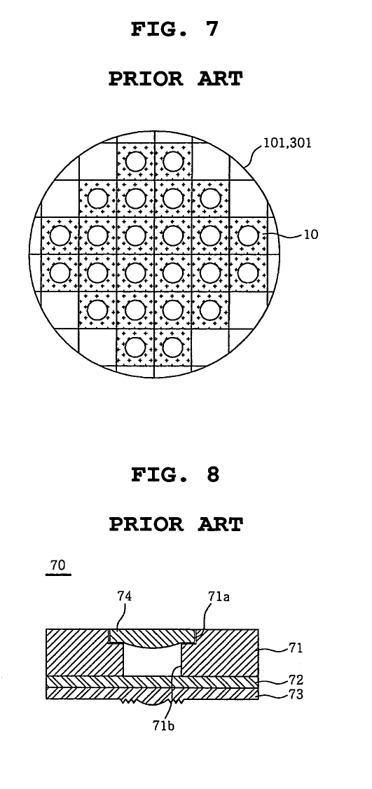

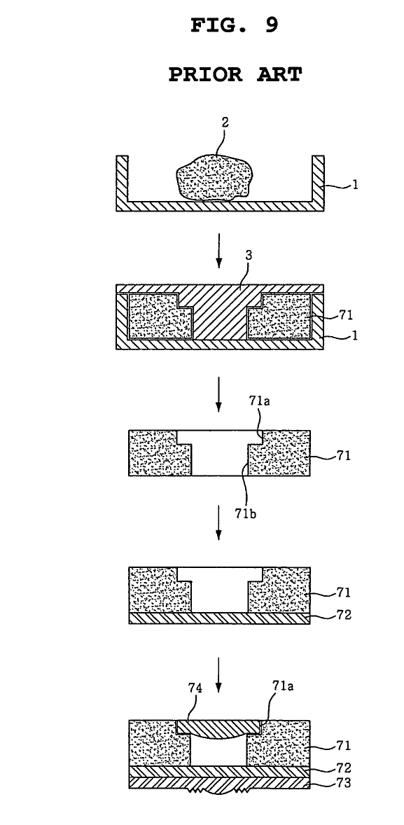

First, a mask member 10, such as a photoresist, is applied on the entire surface of a wafer-sized silicon mother substrate 101 as shown in FIG. 7, which is to be cut into silicon substrates 110, so as to provide a predetermined pattern.

Subsequently, the silicon mother substrate 101 is immersed in an etching solution for Si to be wet etched, thereby forming a coupling recess 11a in which a lens supporter 120 is to be provided. Since the silicon mother substrate 101 is isotropic, the coupling recess 11a has the flat bottom and a inclined wall.

Next, the mask member 10 is removed, and the silicon substrate 110, in detail, a lower part of the silicon mother substrate 101, is longitudinally cut so that the coupling recess 11a is formed through upper and lower parts of the silicon substrate 110, thereby forming a coupling opening 111.

A glass plate 130 is then attached to the lower side of the silicon substrate 110 using predetermined attaching means, such as an anodic bonding. It is preferable that the glass plate 130 be transparent so as to be easily penetrated by light beams.

Thermosetting polymer or UV curable polymer 20 is situated in the coupling opening 111 of the silicon substrate 110, and then pressed using a mold 30 having a predetermined shape. Thermosetting polymer or UV curable polymer 20 is hardened by applying heat or UV to the lower side of the silicon substrate 110 while thermosetting polymer or UV curable polymer 20 is pressed, thereby integrally simultaneously forming the lens supporter 120 and an aspheric lens 150. If the mold 30 is transparent, it is possible to simultaneously apply UV to upper and lower sides of the silicon substrate 110, thereby reducing the hardening time of the UV curable polymer 20, resulting in a reduced production time.

After a diffraction member 140 is attached to a lower side of the glass plate 130, an objective 160 is mounted on the lens supporter 120.

Finally, the silicon mother substrate 101 as shown in FIG. 7 is cut along cutting lines formed thereon into lens holder assemblies 100.

Hereinafter, a description will be given of the production of the lens holder assembly 100 of FIG. 3, referring to FIG. 6.

First, a mask member 10, such as a photoresist, is applied on the entire surface of a wafer-sized glass mother substrate 301 as shown in FIG. 7, which is to be cut into glass substrates 310, so as to provide a predetermined pattern.

Subsequently, the glass mother substrate 301 is immersed in an etching solution for Si to be wet etched, thereby forming a coupling recess 311 in which a lens supporter 320 is to be provided. Since the glass substrate 310 is anisotropic, the coupling recess 311 has a flat bottom and a curved wall.

After the mask member 10 is removed, thermosetting polymer or UV curable polymer 20 is situated in the coupling recess 311 of the glass substrate 310 and then pressed using a mold 30 having a predetermined shape. Next, thermosetting polymer or UV curable polymer 20 is hardened by applying heat or UV to the lower side of the glass substrate 310 while the thermosetting polymer or UV curable polymer 20 is pressed, thereby integrally simultaneously forming the lens supporter 320 and an aspheric lens 340. If the mold 30 is transparent, it is possible to simultaneously apply UV to upper and lower sides of the glass substrate 310, thereby reducing the hardening time of the UV curable polymer 20, resulting in a reduced production time.

After a diffraction member 330 is attached to the lower side of the glass substrate 310, an objective 360 is mounted on the lens supporter 320.

Finally, the glass mother substrate 301 as shown in FIG. 7 is cut along cutting lines formed thereon into the lens holder assemblies 300.

Since the production of the lens holder assemblies 200, 400 of FIGS. 2 and 4 is conducted through a procedure that is similar to the procedure of producing the lens holder assemblies 100, 300 of FIGS. 1 and 3, respectively, a description of the production procedure is omitted.

The above described lens holder according to the present invention may be adapted to any optical devices using lens without any limitations.

Although a lens holder assembly and a method of producing same according to the present invention have been disclosed for illustrative purposes, those skilled in the art will appreciate that various modifications, additions and substitutions are possible, without departing from the scope and spirit of the invention as disclosed in the accompanying claims.

As described above, in a lens holder assembly of an optical pickup and a method of producing same according to the present invention, a wafer-sized silicon mother substrate or glass mother substrate is wet etched to simultaneously form a plurality of coupling openings or coupling recesses, and a glass plate or a diffraction member is directly attached to the silicon mother substrate or glass mother substrate, thereby simultaneously creating a plurality of lens holder assemblies. Subsequently, the lens holder assemblies are separated from each other through a cutting process at the same time. Thus, production is easily achieved and mass-production is feasible.

Furthermore, in the lens holder assembly, since an aspheric lens is formed while thermosetting polymer(thermosetting polymer or UV curable polymer) is shaped into the lens supporter, two lenses, in addition to an objective, are provided, thereby desirably correcting various aberrations. Additionally, since two lenses are used, it is possible to increase freedom in the course of designing the lens in comparison with the use of one thick lens.

As well, since a lens supporter of the lens holder assembly is produced using a silicon substrate or a glass substrate, the lens supporter can desirably withstand external impact or heat applied to the lens holder assembly, thus it is possible to use the lens holder assembly for a long time.

What is claimed is:

1. A lens holder assembly, comprising:
a silicon substrate member through which a coupling opening having a predetermined size is formed by wet etching;
a lens supporter, which is provided in the coupling opening of the silicon substrate member and on which an objective is to be mounted; and
a transparent member, which is attached to a lower side of the silicon substrate member so as to close the coupling opening, and which is penetrated with light beams.

2. The lens holder assembly as set forth in claim 1, wherein the transparent member includes a diffraction member, for correcting chromatic aberrations of the light beams, on a lower side thereof.

3. The lens holder assembly as set forth in claim 1, wherein the transparent member includes an aspheric lens on a portion of an upper side thereof which is exposed by the coupling opening.

4. The lens holder assembly as set forth in claim 3, wherein a lens supporter and the aspheric lens are made of thermosetting polymer.

5. The lens holder assembly as set forth in claim 3, wherein a lens supporter and the aspheric lens are made of ultraviolet (UV) curable polymer.

6. The lens holder assembly as set forth in claim 3, wherein the aspheric lens is integrally formed in conjunction with a lens supporter using a predetermined mold.

7. The lens holder assembly as set forth in claim 1, wherein the transparent member includes a diffraction member for correcting chromatic aberrations of the light beams on a portion of an upper side thereof which is exposed by the coupling opening.

8. The lens holder assembly as set forth in claim 7, wherein a lens supporter and the diffraction member are made of thermosetting polymer

9. The lens holder assembly as set forth in claim 7, wherein a lens supporter and the diffraction member are made of ultraviolet (UV) curable polymer.

10. The lens holder assembly as set forth in claim 7, wherein the diffraction member is integrally formed in conjunction with a lens supporter using a predetermined mold.

11. A lens holder assembly, comprising:
a glass substrate member on which a coupling recess having a predetermined size is formed by wet etching; and
a lens supporter, which is provided in the coupling recess of the glass substrate member, and on which an objective is to be mounted.

12. The lens holder assembly as set forth in claim 11, wherein the glass substrate member includes a diffraction member, for correcting chromatic aberrations of light beams, on a lower side thereof.

13. The lens holder assembly as set forth in claim 11, wherein the glass substrate member includes an aspheric lens on a bottom of the coupling recess.

14. The lens holder assembly as set forth in claim 13, wherein a lens supporter and the aspheric lens are made of thermosetting polymer.

15. The lens holder assembly as set forth in claim 13, wherein a lens supporter and the aspheric lens are made of ultraviolet (UV) curable polymer.

16. The lens holder assembly as set forth in claim 13, wherein the aspheric lens is integrally formed in conjunction with a lens supporter using a predetermined mold.

17. The lens holder assembly as set forth in claim 11, wherein the glass substrate member includes a diffraction member, for correcting chromatic aberrations of light beams, on a bottom of the coupling recess.

18. The lens holder assembly as set forth in claim 17, wherein a lens supporter and the diffraction member are made of thermosetting polymer

19. The lens holder assembly as set forth in claim 17, wherein a lens supporter and the diffraction member are made of ultraviolet (UV) curable polymer.

20. The lens holder assembly as set forth in claim 17, wherein the diffraction member is integrally formed in conjunction with the lens supporter using a predetermined mold.

21. Method of producing a lens holder assembly, comprising the steps of:
forming a plurality of coupling recesses on a wafer-sized silicon mother substrate by wet etching;
cutting a portion of the silicon mother substrate so as to convert the coupling recesses into coupling openings;
attaching a transparent member to a lower side of the silicon mother substrate having a spherical shape so as to close the coupling openings;
feeding polymers into the coupling openings;
shaping the polymers into lens supporters using a predetermined mold; and
cutting the silicon mother substrate into a plurality of lens holder assemblies.

22. The method as set forth in claim 21, further comprising the step of attaching a diffraction member, for correcting chromatic aberrations of light beams, to a lower side of the transparent member after the shaping step.

23. The method as set forth in claim 22, wherein aspheric lenses are integrally formed in conjunction with lens supporters on portions of an upper side of the transparent member, which is exposed by coupling openings in the shaping step.

24. The method as set forth in claim 21, wherein diffraction members are integrally formed in conjunction with the lens supporters on portions of an upper side of the transparent member, which is exposed by the coupling openings in the shaping step.

25. A method of producing a lens holder assembly, comprising the steps of:
forming a plurality of coupling recesses on a wafer-sized glass mother substrate by wet etching;
feeding polymers into the coupling recesses;
shaping the polymers into lens supporters using a predetermined mold; and
cutting the glass mother substrate into a plurality of lens holder assemblies.

26. The method as set forth in claim 25, further comprising the step of attaching a diffraction member, for correcting chromatic aberrations of light beams, to a lower side of the glass mother substrate after the shaping step.

27. The method as set forth in claim 26, wherein aspheric lenses are integrally formed in conjunction with lens supporters on bottoms of coupling recesses in the shaping step.

28. The method as set forth in claim 25, wherein diffraction members are integrally formed in conjunction with the lens supporters on bottoms of the coupling recesses in the shaping step.
